(19) United States
(12) Patent Application Publication
(10) Pub. No.: US 2010/0026444 A1
(43) Pub. Date: Feb. 4, 2010

(54) MAGNETIC ELEMENT

(76) Inventors: Cheng-Hong LEE, Taoyuan Hsien (TW); Yu-Ling Hsueh, Taoyuan Hsien (TW); Yi-Hong Huang, Taoyuan Hsien (TW)

Correspondence Address: Muncy, Geissler, Olds & Lowe, PLLC, P.O. BOX 1364, FAIRFAX, VA, 22038-1364, US

(21) Appl. No.: 12/208,729

(22) Filed: Sep. 11, 2008

(30) Foreign Application Priority Data
Jul. 29, 2008 (TW) 097128641

(51) Int. Cl. H01F 27/36

(52) U.S. Cl. 336/84 M

(57) ABSTRACT

A magnetic element includes a core, a coil and a magnetic shield. The coil is wound around the core. The magnetic shield that contains a Fe-based powder is used to cover the coil and at least a part of the core so as to reduce the noise interference on the magnetic element.

### CROSS REFERENCE TO RELATED APPLICATIONS

This Non-provisional application claims priority under 35 U.S.C. §119(a) on Patent Application No(s). 097128641 filed in Taiwan, Republic of China on Jul. 29, 2008, the entire contents of which are hereby incorporated by reference.

### BACKGROUND OF THE INVENTION

1. Field of Invention

The present invention is related to a magnetic element.

2. Related Art

Accompanying the progressive of technology, many active elements and passive elements can be applied to the integrated circuit (IC). The passive elements are resistors, capacitors, or inductors.

As shown in FIG. 1, a conventional inductor 1 includes a core 11, a coil 12, a fixing layer 13, and two electrodes 141 and 142. The coil 12 is wound around the core 11, and the two electrodes 141 and 142 are electrically connected to the coil 12, respectively. The fixing layer 13, used to cover a part of the coil 12, is made of epoxy resin. As the inductor 1 is driven, since it is an open magnetic loop, the inductance of the inductor 1 is lower. Furthermore, since a part of the coil 12 is exposed outside the fixing layer 13, this causes the noise interference on the inductor 1.

### SUMMARY OF THE INVENTION

In view of the foregoing, an objective of the present invention is to provide a magnetic element that has a closed magnetic loop and is not easily interfered by the noise.

To achieve the above objective, a magnetic element of the present invention includes a core, a coil, and a magnetic shield. The coil is wound around the core, and the magnetic shield is used to cover the coil completely and at least a part of the core.

The magnetic shield contains iron (Fe), silicon (Si), nickel (Ni), molybdenum (Mo), aluminum (Al), or a combination thereof such as Fe, Fe/Si, Fe/Ni, Mo/Fe/Ni, or Fe/Si/Al alloy.

Alternatively, the material of the magnetic shield contains an iron-based powder, iron powder, or iron-based alloy. For example, the iron-based powder ranges from 30 to 85 percent based on the weight of the magnetic shield.

The material of the magnetic shield further includes resin.

In addition, the magnetic element further includes an electrode electrically connected with the coil.

Preferably, the magnetic element further includes a magnetic substrate. The core is disposed at one side of the magnetic substrate. The magnetic substrate contains Fe, Si, Ni, Mo, Al, or a combination thereof such as Fe, Fe/Si, Fe/Ni, Mo/Fe/Ni, or Fe/Si/Al alloy. Alternatively, the material of the magnetic substrate contains an iron-based powder, iron powder, or iron-based alloy. The iron-based powder ranges over 85 percent based on the weight of the magnetic substrate.

In addition, the magnetic substrate includes resin.

The magnetic shield is used to cover the coil, the core, and at least a part of the magnetic substrate. The magnetic shield can be formed by glue injection or injection molding. The magnetic substrate, core and coil form a closed magnetic loop.

Moreover, the magnetic element further includes an adhesive layer located between the magnetic substrate and the core.

As described above, the magnetic element of the present invention can reduce the noise interference thereon by using the magnetic shield to cover the coil and at least a part of the core, or to cover the coil, the core, and a part of the magnetic substrate. Furthermore, since the magnetic substrate, core and coil form a closed magnetic loop, the inductance of the magnetic element according to the present invention can be increased.

### BRIEF DESCRIPTION OF THE DRAWINGS

The present invention will become more fully understood from the detailed description given herein below and the accompanying drawings which are given by way of illustration only, and thus are not limitative of the present invention, and wherein:

FIG. 1 is a schematic view of the conventional inductor;

FIG. 2 is a schematic view of a magnetic element according to a first embodiment of the present invention; and

FIG. 3 is a schematic view of a magnetic element according a second embodiment of the present invention.

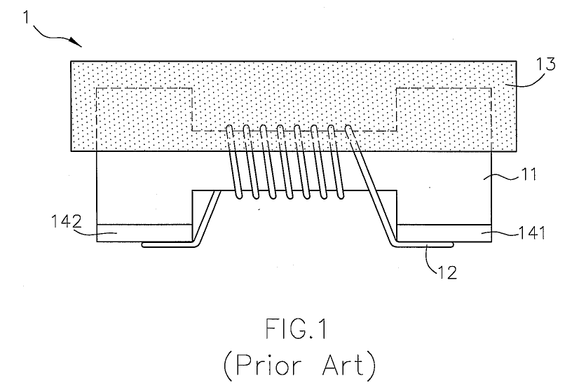

### DETAILED DESCRIPTION OF THE INVENTION

The present invention will be apparent from the following detailed description, which proceeds with reference to the accompanying drawings, wherein the same references relate to the same elements.

With reference to FIG. 2, a magnetic element 2 according to a first embodiment of the present invention includes a core 21, a coil 22, and a magnetic shield 23. The coil 22 is wound around the core 21.

The material of the magnetic shield 23 includes an iron containing material such as iron-based powder, iron powder, or iron-based alloy. Alternatively, the magnetic shield 23 includes Fe, Si, Ni, Mo, Al, or a combination thereof, for example but not limited to, Fe, Fe/Si, Fe/Ni, Mo/Fe/Ni or Fe/Si/Al alloy. Furthermore, the material of the magnetic shield 23 according to the present invention further includes resin which can be mixed with the iron-based powder to form the magnetic shield 23. After the iron-based powder and resin are well mixed, the iron-based powder ranges from 30 to 85 percent based on the weight of the magnetic shield 23.

In the embodiment, the magnetic shield 23 is used to cover the coil 22 and at least a part of the core 21 so as to reduce the noise interference on the magnetic element 2. In addition, the magnetic shield 23 is also used to hold the coil 22. For example, the magnetic shield 23 covers the coil 22 and the entire core 21. The magnetic shield 23 can be formed by glue injection or injection molding. Moreover, the magnetic element 2 of the present invention further includes two electrodes 261 and 262 electrically connected with the coil 42, respectively.

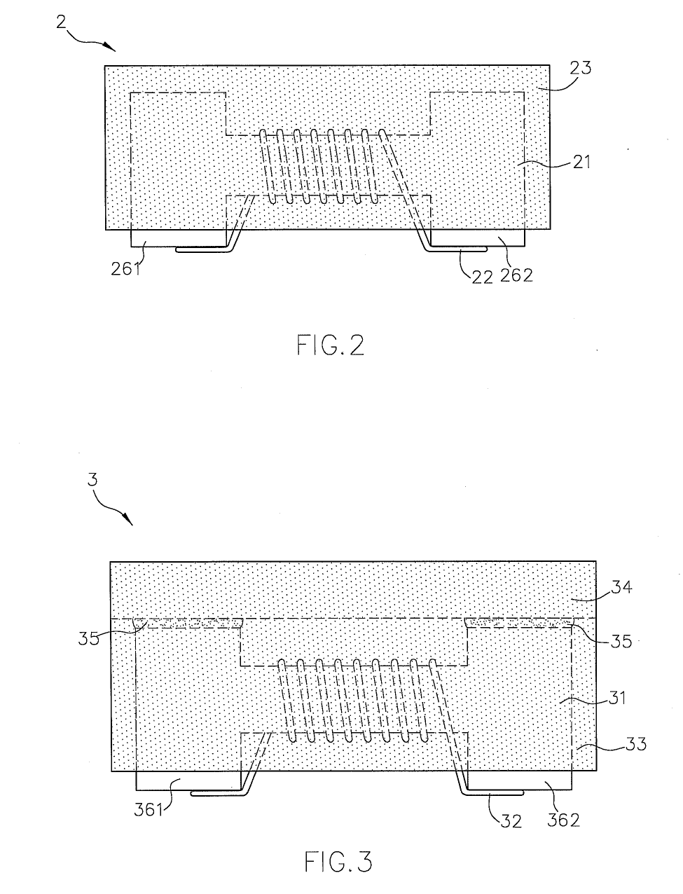

With reference to FIG. 3, a magnetic element 3 according to a second embodiment of the present invention includes a core 31, a coil 32, and a magnetic substrate 34. The coil 32 is wound around the core 31, and the core 31 is disposed at one side of the magnetic substrate 34. The magnetic substrate 34 includes an iron-containing material such as iron-based powder, iron powder, or iron-based alloy. Alternatively, the magnetic substrate 34 includes Fe, Si, Ni, Mo, Al, or a combination thereof, for example but not limited to, Fe, Fe/Si, Fe/Ni, Mo/Fe/Ni or Fe/Si/Al alloy. The magnetic substrate 34 further includes resin which can be mixed with the iron-based powder to form the magnetic substrate 34. After the iron-based powder and resin are well mixed, the iron-based powder ranges over 85 percent based on the weight of the magnetic substrate 34.

In the embodiment, the magnetic substrate 34, core 31, and coil 32 form a closed magnetic loop. Compared to the prior art, the preferred characteristics of a larger bandwidth, a larger inductance, and a low coil resistance are found in the magnetic element 3 of the present invention after it is being actually measured.

The magnetic element 3 of the present invention further includes an adhesive layer 35 and two electrodes 361 and 362. The adhesive layer 35 is disposed between the magnetic substrate 34 and the core 31 so as to bond the magnetic substrate 34 and the core 31. The two electrodes 361 and 362 are electrically connected with the coil 32, respectively.

Additionally, the magnetic element 3 of the present invention further includes a magnetic shield 33 that is used to cover the core 31, the coil 32, and a part of the magnetic substrate 34 so as to protect the magnetic element 3 and reduce the noise interference thereon.

The magnetic shield 33 includes iron-containing material such as iron-based powder, iron powder, or iron-based alloy. Alternatively, the magnetic shield 33 can include Fe, Si, Ni, Mo, Al, or a combination thereof, for example but not limited to, Fe, Fe/Si, Fe/Ni, Mo/Fe/Ni or Fe/Si/Al alloy. The magnetic shield 33 further includes resin which can be mixed with the iron-based powder to form the magnetic shield 33. After the iron-based powder and resin are well mixed, the iron-based powder ranges from 30 to 85 percent based on the weight of magnetic shield 33.

The magnetic shield 33 can be formed by glue injection or injection molding. The magnetic shield 33 is also used to hold the coil 32.

To sum up, the core and the coil form the closed magnetic loop in the magnetic element of the present invention. Compared to the prior art, the preferred characteristics of a larger bandwidth, a larger inductance, and a low coil resistance are found in the magnetic element of the present invention. Additionally, the magnetic element of the present invention can reduce the noise interference thereon by using the magnetic shield to cover the coil and at least a part of the core, or to cover the coil, the core, and a part of the magnetic substrate.

Although the present invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the present invention.

What is claimed is:

1. A magnetic element comprising:
a core;
a coil wound around the core; and
a magnetic shield covering the coil and at least a part of the core.

2. The magnetic element according to claim 1, wherein the magnetic shield comprises Fe, Si, Ni, Mo, Al, or a combination thereof.

3. The magnetic element according to claim 2, wherein the magnetic shield comprises Fe, Fe/Si, Fe/Ni, Mo/Fe/Ni, or Fe/Si/Al alloy.

4. The magnetic element according to claim 1, wherein the material of the magnetic shield comprises an iron-based powder, an iron powder, or an iron-based alloy.

5. The magnetic element according to claim 4, wherein the iron-based powder ranges from 30 to 85 percent based on the weight of the magnetic shield.

6. The magnetic element according to claim 1, wherein the magnetic shield comprises resin.

7. The magnetic element according to claim 1, further comprising an electrode electrically connected with the coil.

8. The magnetic element according to claim 1, further comprising a magnetic substrate, wherein the core is disposed at one side of the magnetic substrate.

9. The magnetic element according to claim 8, wherein the magnetic substrate comprises Fe, Si, Ni, Mo, Al, or a combination thereof.

10. The magnetic element according to claim 8, wherein the magnetic substrate comprises Fe, Fe/Si, Fe/Ni, Mo/Fe/Ni, or Fe/Si/Al alloy.

11. The magnetic element according to claim 8, wherein the material of the magnetic substrate comprises an iron-based powder, an iron powder, or an iron-based alloy.

12. The magnetic element according to claim 11, wherein the iron-based powder ranges over 85 percent based on the weight of the magnetic substrate.

13. The magnetic element according to claim 8, wherein the magnetic substrate comprises resin.

14. The magnetic element according to claim 8, wherein the magnetic shield covers the coil, the core, and at least a part of the magnetic substrate.

15. The magnetic element according to claim 8, wherein the magnetic substrate, the core, and the coil form a closed magnetic loop.

16. The magnetic element according to claim 8, further comprising an adhesive layer located between the magnetic substrate and the core.

17. The magnetic element according to claim 1, wherein the magnetic shield is formed by glue injection or injection molding.
